(19) United States
(12) Patent Application Publication
(10) Pub. No.: US 2005/0140700 A1
(43) Pub. Date: Jun. 30, 2005

(54) Display device whose display area is divided in groups of pixels; each group provided with scaling means

(76) Inventors: Renatus Josephus Van Der Vleuten, Eindhoven (NL); Mark Thomas Johnson, Eindhoven (NL); Herbert Lifka, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/501,694

(22) PCT Filed: Dec. 12, 2002
(86) PCT No.: PCT/IB02/05502

(30) Foreign Application Priority Data
Jan. 18, 2002 (EP) 02075214.3

(51) Int. Cl. G09G 5/02

(52) U.S. Cl. 345/698

(57) ABSTRACT

ICs or separate semiconductor areas are provided on a carrier e.g. in a bus structure or at the crossing of rows and columns. The separate semiconductor areas contain electronics (address of pixel in memory, identification) to drive groups of pixels and to provide a distributed scaling of displays and subsequently drive the pixels dependent on distributed or averaged information. A controller may further determine whether data is supplied, dependent on successive frames of information

The invention relates to a display device comprising a substrate, which is provided with groups of pixels and at least one semiconductor device associated with each group of pixels and being provided at the area of said group of pixels.

Examples of such active matrix display devices are TFT-LCDs or AM-LCDs, which are used in laptop computers and in organizers, but also find an increasingly wider application in GSM telephones. Instead of LCDs, for example, (polymer) LED display devices may also be used.

A general problem in these types of display devices is the fact that the distribution of picture elements (pixels) in a display does not always comply with the format of the picture data that is provided to the display device. For instance in certain applications it may be useful to have the opportunity to reproduce either a VGA (640×480 pixels) image or an XGA (1024×768 pixels) image onto an XGA resolution screen or vice versa. Similar remarks apply to reproducing either a SVGA (pixels) image or an SXGA (1280×1024 pixels) image onto an XGA or VGA resolution screen or vice versa, etcetera.

A further general problem in these types of display devices is the fact that the provision of extra electronics at the area of the pixels is at the expense of the aperture. The electronics may be realized on the substrate in polycrystalline silicon. Manufacturing tolerances and interconnections however generally limit the electronics at the area of the pixels to simple functions. So electronics in polysilicon generally remains restricted to peripheral circuitry.

The invention however provides a display device, in which the semiconductor device at he area of said group of pixels is provided with drive means for driving the pixels dependent on data to be displayed and with picture scaling means.

Preferably the semiconductor devices are provided with means for recognizing the location of the group of pixels.

For example, an 8-bit bus configuration is possible now through which the address information and the picture information are consecutively passed. In this case, by sending data about the kind of scaling of the image to be displayed via the bus structure a lower frequency may be used for driving the display device, which reduces the dissipation. This is possible because the semiconductor devices (ICs) can comprise drive electronics at the area of the pixels. This provides the possibility to provide for instance a picture scaling function within each group of pixels.

It is possible to provide the ICs at a defined position (within a group of pixels) by providing a semiconductor substrate with a plurality of semiconductor devices having electric connection contacts on their surface. The semiconductor devices are mutually separated in a surface region of an original semiconductor substrate, and the electric connection contacts are connected to a conductor pattern of the display in an electrically conducting manner. The semiconductor devices are then separated from the semiconductor substrate.

Since the location of an IC to be provided is known in advance, it can be provided in advance (during IC processing (ROM structure) or via e-PROM techniques), for example, with an address register or with one or more data registers. The address is provided in the data, sent over the bus and is recognized by certain ICs (and associated (groups) of pixels) and picture information in a certain format is stored. Thereafter, the picture information is redistributed (scaled up or down) if necessary and corresponding voltages are supplied to pixels, if necessary dependent on possible further commands. So the device provides, as it were, a kind of “distributed scaling”.

Notably, but not exclusively, when using monocrystalline silicon, it is possible (as mentioned above) to realize complete functions allowing a different type of architecture of the display device than the architecture used in conventional matrix structure, for example, a bus structure. Since the ICs are manufactured in advance, more extensive electronic functions than in the conventional polysilicon technology can be realized, although the invention does not preclude the realization of the scaling and rescaling functions in polysilicon technology. Consequently in the context of this patent (application) the term “semiconductor devices” also comprises separate polysilicon areas.

Especially when using ICs as the semiconductor devices, since these are situated with respect to each other in exactly the same way as on the semiconductor substrate during their fixation to the substrate, these ICs are provided at a very accurate pitch. This may be a constant pitch in one direction such as in matrix-shaped configurations of the pixels. The pitch may alternatively be variable.

Moreover, the semiconductor devices (ICs) are realized in a semiconductor layer whose thickness is typically 0.2 micrometer. The result is that these semiconductor devices in the finished display device have a negligible thickness (less than 1 micrometer). In, for example, display devices based on thickness-sensitive effects such as the STN effect, this is so small with respect to the effective thickness of the liquid layer that said effects do not occur, not even in the presence of a spacer at the location of an IC.

The article “Flexible Displays with Fully Integrated Electronics”, SID Int. Display Conf., September 2000, pp. 415 to 418 describes a process in which specifically formed semiconductor devices in a liquid suspension are passed across a substrate and reach correspondingly formed “apertures” or indentations in the substrate. The semiconductor devices (usually ICs which are manufactured via standard techniques) are arbitrarily distributed across the indentations in the substrate. After the ICs have been provided, connections with pixels are established.

Since the exact position of such an IC is not known in advance now, it must be fixed in a special way when using a bus structure, for example, by means of (an optical sensor and) a programmable memory so that this address information can be programmed with, for example, a laser beam.

The “distributed scaling” has different applications. Since in fact information is now written into the local memories of the semiconductor devices, all kinds of scaling electronics, including the implementation of algorithms as known in the art now extend as far as these semiconductor devices. This on the other hand simplifies or partly replaces driving electronics as used in conventional displays.

In one embodiment if the picture information as provided has information corresponding to a part of the pixels to be displayed (e.g. when displaying XGA information on a QXGA display) the picture scaling means provide several pixels within a group of pixels with the same data voltages.

If on the other hand the picture information as provided has information corresponding to more pixels than those available for displaying (e.g. when displaying QXGA information on a XGA display) the picture scaling means comprise an averaging function for data to be displayed on a single picture element.

To prevent sharp edges between such groups of pixels the picture scaling means may determine intermediate voltages for neighboring pixels. Since on the other hand such smoothing should not effect sharp lines, it is useful to introduce the possibility to determine intermediate voltages for pixels in neighboring columns or for pixels in neighboring rows.

In one embodiment the addressing rate of the semiconductor devices is variable for instance if the driving means comprise a frame memory and means to detect changes between the contents of subsequent frames. On the other hand said detection may take place in further driving means for the display, such as e.g. a microprocessor or other driving circuit, which provides addresses and data to said bus circuitry.

These and other aspects of the invention are apparent from and will be elucidated with reference to the embodiments described hereinafter.

In the drawings:

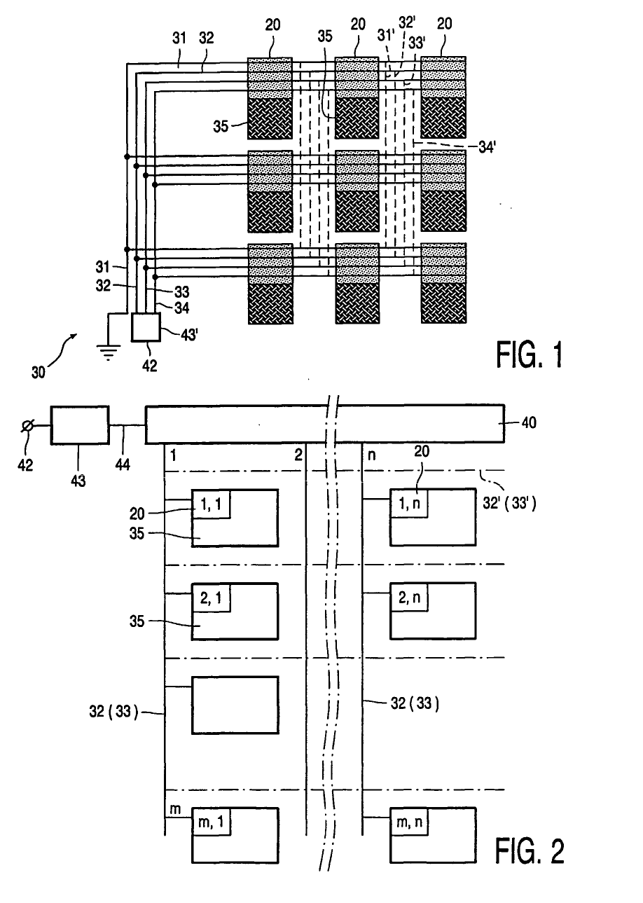

FIG. 1 is an electrical equivalent of a possible embodiment of a display device according to the invention,

FIG. 2 is an electrical equivalent of another embodiment of a display device according to the invention,

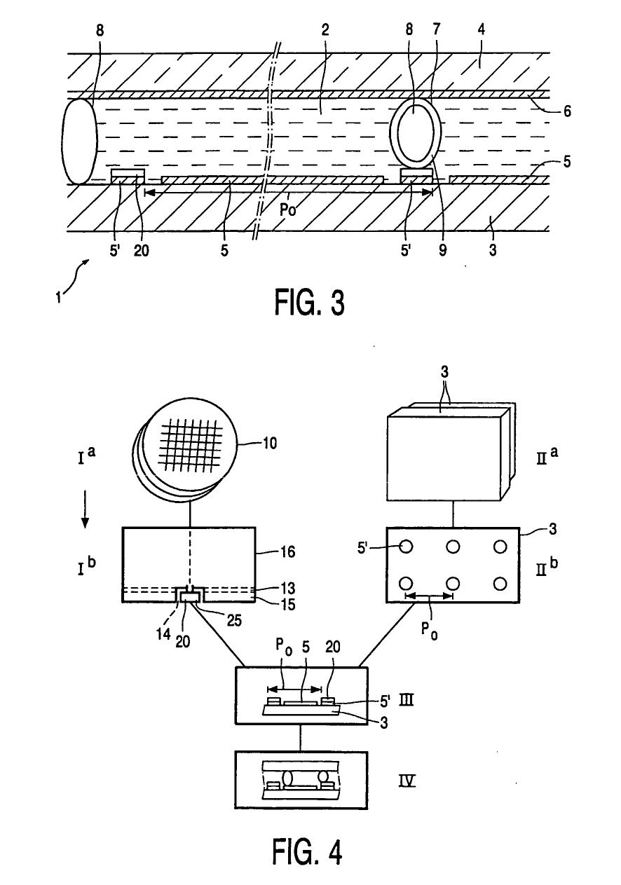

FIG. 3 is a diagrammatic cross-section of a part of a display device according to the invention,

FIG. 4 is a flow chart of a method of manufacturing a display device according to the invention,

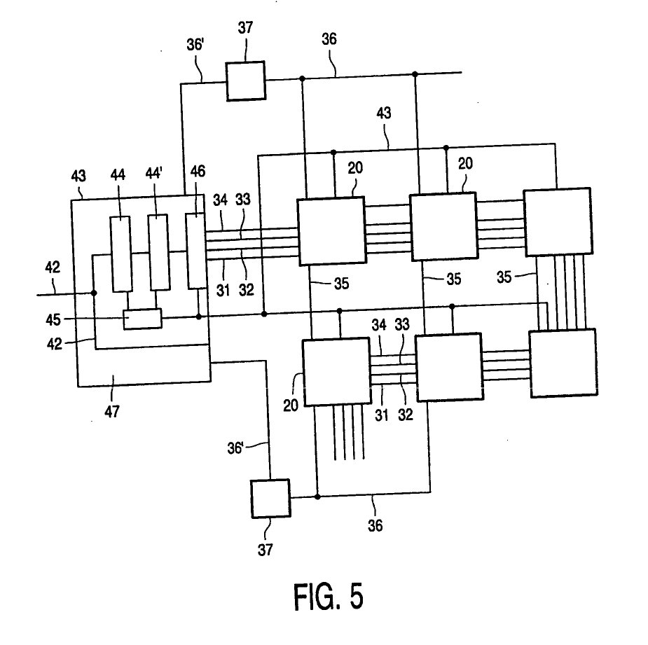

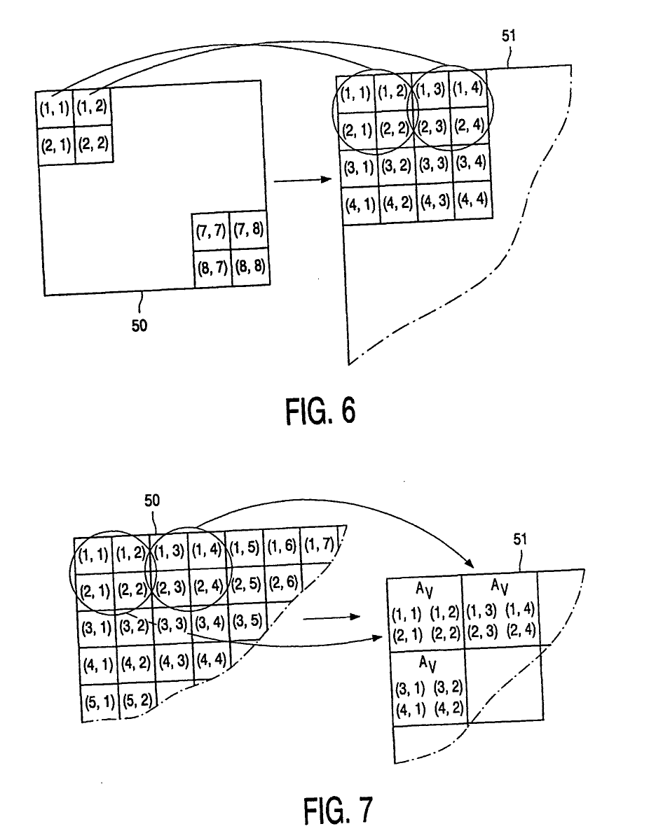

FIG. 5 is a diagrammatic part of a display device according to the invention, while FIGS. 6 and 7 diagrammatically show methods of scaling and

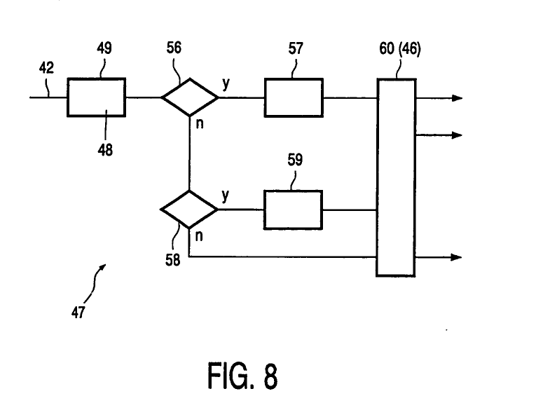

FIG. 8 shows an algorithm used

The Figures are diagrammatic and not drawn to scale. Corresponding elements are generally denoted by the same reference numerals.

FIG. 1 shows diagrammatically an equivalent of a display device 30 having a bus structure. ICs (semiconductor devices) 20 are connected to a power supply voltage via connection lines 31, 32 (in this example, line 31 is connected to earth), while the lines 33, 34 (serially) supply information and, for example, a clock signal. The information after passing a processor 43, is structured, for example in such a way that the first bits comprise the address information and the last bits comprise the information about the picture contents. Although only two lines 33, 34 are shown, they form, for example, an 8-bit bus through which the address information and the picture information are consecutively passed. Alternatively information may be superimposed on the power supply lines 31, 32. Since, as will be further described, the location of an IC is known or not known in advance, it may be provided with a fixed address by an address register and one or more data registers. For given ICs (and associated (groups) of pixels 35), the address is recognized by the ICs and picture information is stored, whereafter it is applied to the pixels 35, dependent on commands also to be given through the lines 33, 34.

The bus structure may be formed as a mesh structure (denoted by broken lines 31′, 32′, 33′, 34′ in FIG. 1) so that the resistance is decreased (and hence again the dissipation).

Other functions may also be accommodated in the IC. For example, a part of the display device may be blocked for changes of information by means of a command register built in the IC, or may be used for storing the information in the IC for a part of the display device, which information is only displayed at command (so-called “private mode”). Various algorithms for picture processing (for example, gamma correction) or driving may also be realized in the ICs.

FIG. 2 is an electric equivalent of another display device 30 to which the invention is applicable. FIG. 2 shows a plurality of pixels arranged or not arranged in groups 35 in a matrix structure. In the display device, each group 35 comprises the means for recognizing the location, for example, a command register (not shown). The command registers are in turn programmed with a given address and recognize the associated address information as described with reference to FIG. 1, when this information is presented on the bus lines 32 (e semiconductor device may also comprise a flip-flop in which, dependent on the state of this flip-flop, information is displayed again (“private mode”). The bus electrodes are provided with data, commands, etc. via, for example, a drive circuit 40. If necessary, incoming data signals 42 first pass a processor 43. Mutual synchronization takes place via drive lines 44. Since the data, commands and other signals are now presented via a divided bus structure to the groups 35, this consumes less power (the data, commands, etc. are presented at a lower frequency). If necessary, a mesh structure may also be used again in this case.

In the relevant example, the pixels form part of a liquid crystal display device, but (O)LED display devices are alternatively possible, as well as display elements based on other effects (electrophoretic, electrochromic or micromechanical effects, switching mirror devices, foil displays or field emission displays).

FIG. 3 is a diagrammatic cross-section of a part of a light-modulating cell 1 with a liquid crystal material 2 which is present between two substrates 3, 4 of, for example, glass or synthetic material, provided with (ITO or metal) electrodes 5, 6. Together with an intermediate electro-optical layer, parts of the electrode patterns define pixels. If necessary, the display device comprises orientation layers (not shown) which orient the liquid crystal material on the inner walls of the substrates. The liquid crystal material may be a (twisted) nematic material having, for example, a positive optical anisotropy and a positive dielectric anisotropy, but may also make use of a bistable effect such as the STN effect, or the chiral nematic effect, or the PDLC effect. The substrates 3, 4 are customarily spaced apart by spacers 7, while the cell is sealed with a sealing rim 8 which is customarily provided with a filling aperture. A typical thickness of the layer of liquid crystal material 2 is, for example, 5 micrometers. The electrodes 5, 5′ have a typical thickness of 0.2 micrometer, while also the thickness of the semiconductor devices (ICs) 20 is about 0.2 micrometer in this example. In FIG. 3, a spacer 7 is shown at the location of an electrode 5′ and IC 20. The overall thickness of electrode and IC 20 is substantially negligible as compared with the thickness of the layer of liquid crystal material 2. The presence of the spacer 7 does not have any influence, or hardly has any influence, on the opto-electrical properties of the display device, notably when spacers with a hard core 8 and an elastic envelope 9 having a thickness of about 0.2 micrometer are chosen. If necessary thicker IC's can be used which also function as spacer (or a through metallization may even be realized).). The other side of the IC may then have one or more contacts, which provide connections (for electrical signals) to the other substrate.

For manufacturing the semiconductor devices (transistors or ICs) 20, in this example use is made of conventional techniques. The starting material is a semiconductor wafer 10 (see FIG. 4, step 1a, FIG. 3), preferably silicon, with a p-type substrate 11 on which an n-type epitaxial layer 15 having a weak doping (10¹⁴ atoms/cm³) is grown. Prior to this step, a more heavily doped n-type layer 13 (doping about 10¹⁷ atoms/cm³) is provided by means of epitaxial growth or diffusion. Further process steps (implantation, diffusion, etc.) realize transistors, electronic circuits or other functional units in the epitaxial layer 15. After completion, the surface is coated with an insulating layer such as silicon oxide. Contact metallizations are provided via contact apertures in the insulating layer by means of techniques that are customary in the semiconductor technology.

In a variant in which the transistors, electronic circuits or other functional units are realized in the SOI technology in which a thin surface area is embedded in an insulating layer, contact metallizations may be directly provided on contact regions of the transistors of the semiconductor devices.

Subsequently, the n-type regions 14 are subjected via a mask to an etching treatment with HF (under the influence of an electric field). In this treatment, the heavily doped n-type region 14 is isotropically etched, as well as the underlying n-type epitaxial layer 13. The weakly doped n-type epitaxial layer 15 is, however, etched anisotropically so that, after a given period, only a small region 25 remains in this layer (see FIG. 4, step 1b).

The transistors, electronic circuits (ICs) or other functional units are, however, still at their originally defined position. A regular pattern of such units will generally be manufactured at a fixed pitch.

Prior to, simultaneously with or after this treatment, substrates 3 of the display device are provided with metallization patterns which (also at defined positions) will comprise one or more electrodes 5′ (FIG. 4, steps II^{a}, II^{b}). In this example, the parts 5′ of the metallization patterns on the substrate 3 are ordered similarly (the same pitch in different directions) as the electronic circuits (ICs) 20 in the semiconductor wafer 10.

In a subsequent step, the semiconductor wafer 10 is turned upside down, in which the metallization patterns 5′ on the substrate 3 are accurately aligned with respect to the electronic circuits (ICs) 20 in the semiconductor wafer 10, whereafter electrical contact is realized between metallization patterns 5′ and contact metallizations. To this end, use is made of, for example, a conducting glue or anisotropically conducting contacts on the electrodes 5′. The electronic circuits (ICs) 20 are detached from the semiconductor wafer 10 by means of vibration or by a different method. A substrate 3 is then obtained which is provided with picture electrodes 5 and ICs 20 which are very accurately aligned both with respect to the picture electrodes 5 and with respect to each other (step III in FIG. 4). Moreover, the reduction of aperture is exclusively determined by the dimension of the ICs (or transistors).

The display device 1 is subsequently completed in a customary manner, if necessary, by providing orientation layers, which orient the liquid crystal material on the inner walls of the substrate. Spacers 7 are customarily provided between the substrates 3, 4, as well as a sealing rim 8, which is customarily provided with a filling aperture, whereafter the device is filled with LC material in this example (step IV in FIG. 4).

Since the semiconductor devices (ICs) 20 are made in advance, more extensive electronic functions can be realized therein than in the conventional polysilicon technology. Notably when using monocrystalline silicon or recrystallized polysilicon, it is possible to realize functions with which a different type of architecture of the display device can be made possible than with the conventional matrix structure.

In the example of FIG. 5 incoming data signals 42 are provided in a digital or analogue form to the processor 43 and, if necessary after further processing, distributed to the ICs (semiconductor devices) 20 via connection lines (bus lines) 31, 32 33, 34.

In a typical example (FIG. 6) data comprising e.g. luminance values for a SVGA screen (600 lines×800 columns) are written into a memory device in electronic block (IC) 20 for a block of 8×8 pixels. Via suitable electronics such as D-A converters, counters and registers in electronic block (IC) 20 (not shown in FIG. 5) pixel electrodes in a group of 8×8 pixels are subsequently provided with the associated voltages. If the display device itself has a SVGA architecture (600 lines×800 columns) a perfect match occurs.

However if the display device has a UXGA architecture (1200 lines×1600 columns) data for one pixel in the information block 50 has to be spread over four different pixels in the display area 51, as shown in FIG. 6. Data block (1,1) is spread over pixels (1,1), (1,2), (2,1), (2,2), while data block (1,2) is spread over pixels (1,3), (1,4), (2,3), (2,4) etc.

On the other hand if the display device has a SVGA screen (600 lines×800 columns) but the data block comprises UXGA (1200 lines×1600 columns) data luminance values the values for one picture element of the screen are provided with for example an average value of the pixel values as given in the data block (FIG. 7). Pixel 1,1 is provided with a voltage determined by the average value of data (1,1), (1,2), (2,1), (2,2) etcetera.

Both the spreading out as discussed with respect to FIG. 6 and the determination of the average value as discussed with respect to FIG. 7 may not always lead to a better display of the original picture. For instance, if straight lines, e.g. a horizontal or vertical, are displayed, it is preferred to restrict the edges to one line or column of the display. To this end signal lines 35 between electronic blocks (IC)s 20 are provided (FIG. 5). Together with electronic circuitry in the blocks (IC)s 20 comparison with data for parts of the same picture lines (columns) is made to decide whether spreading out or averaging should occur.

Apart from this all other kinds of algorithms for image processing and contouring may be implemented in the electronic blocks (IC)s 20, such as for example a rotation of the image. The electronic blocks (IC)s 20 should obtain information about the orientation of the display via signals 36 obtained by sensors 37. Said information contains for instance data about direction and angle of rotation (90, 180 degrees). The sensors may be mechanical sensors, photo detectors etc. On the other hand the signals 36′ obtained by sensors 37 may be sent directly to the processor 43. Also algorithms may be implemented in which not all data is sent to the electronic blocks (IC)s 20 and intermediate pixel voltages for pixels in neighboring columns or rows are determined. To avoid contouring it is also possible to reconfigure the pixel driving between two frames (the positive and negative frame in a LCD) by shifting the address by one position in any direction. This leads to a smoother, interpolated display image.

Especially if still pictures are displayed there is little or no need to provide the ICs (semiconductor devices) 20 with new data and the transfer of data can be restricted to updating the contents of the IC memory. To this end the processor 43 (FIG. 5a) comprises frame memories 44, 44′ in which the contents of subsequent frames of information are stored. The contents are compared in a comparator 45 and, dependent on the outcome, a buffer circuit 46 is enabled to provide the bus lines 33, 34 with fresh data. Also only subframes may be compared, e.g. in picture in picture applications. On the other hand the subframes which are compared may correspond with the pixel information associated with a certain electronic block (IC) 20 and the corresponding pixels in a group 35 of 8×8 pixels.

If necessary comparison of the contents of subsequent (sub) frames may be incorporated in the electronic blocks (ICs) 20.

Apart from this the contents of the memory may be updated every n frames, n being a large number to prevent errors due to leakage in transistors. Such leakage may also be detected by monitoring current via an extra resistor and setting a flip-flop or generating a signal 36 from the ICs (semiconductor devices) 20 to the processor 43.

To display pictures, which are provided in a certain format the ICs (semiconductor devices) 20 comprise means 47 to determine the kind of formatting (FIG. 8). The display format is for instance determined by format control signals sent to all drivers (ICs 20) via the bus circuit.

The incoming data 42 together with information 49 about the display format is used to determine the kind of scaling (block 48). The information 49 about the display may either be programmed in the ICs (semiconductor devices) 20 or be determined in advance, e.g. by setting a flip-flop or otherwise. The incoming data 42 and information 49 is subsequently compared to decide about the scaling needed. In this example it is first decided (block 56) whether the information has to be spread over a number of different pixels. If this is the case a spreading algorithm, comparable to the method as described with reference to FIG. 6 is used (block 57). If information from incoming data 42 has to be compressed (which is decided afterwards in this example, block 58) an averaging algorithm, comparable to the method as described with reference to FIG. 7 is used (block 59). The resulting data is provided to an output buffer 60 which provides the pixels with the necessary voltage. If neither compression nor scaling is necessary the data is provided to output buffer 60 without any change.

The protective scope of the invention is not limited to the embodiments described. Scaling can be realized by supplying each of the distributed drivers (ICs 20) with a multiplicity of addresses, related to a similar number of display formats (VGA, SVGA, XGA, UXGA, SXGA, QXGA etc.). The display format is for instance determined by format control signals sent to all drivers (ICs 20) via the bus circuit. In the distributed drivers (ICs 20) the appropriate format may be defined a priori by a permanent memory (flip-flops, ROM, etc.).

As stated in the opening paragraph, the pixels may also be formed by (polymer) LEDs which may be provided separately or as one assembly, while the invention is also applicable to other display devices, for example, plasma displays, foil displays and display devices based on field emission, electro-optical or electromechanical effects (switchable mirrors).

Alternatively, as stated, flexible substrates (synthetic material) may be used (wearable displays, wearable electronics). Also the possibility of manufacturing, for example circular or elliptic display devices is not excluded.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device comprising a substrate, which is provided with groups of pixels and at least one semiconductor device associated with each group of pixels and being provided at he area of said group of pixels, the semiconductor device being provided with drive means for driving pixels dependent on data to be displayed and with picture scaling means.

2. A display device as claimed in claim 1, wherein the picture scaling means comprise means to determine the kind of scaling to be performed.

3. A display device as claimed in claim 1, wherein the picture scaling means provide several pixels within a group of pixels with the same data voltages.

4. A display device as claimed in claim 3, wherein the picture scaling means determine intermediate voltages for neighboring pixels.

5. A display device as claimed in claim 4, wherein the picture scaling means determine intermediate voltages for pixels in neighboring columns.

6. A display device as claimed in claim 4, wherein the picture scaling means determine intermediate voltages for pixels in neighboring rows.

7. A display device as claimed in claim 4 comprising a further connection between neighboring semiconductor devices

8. A display device as claimed in claim 4, wherein the driving means comprise a frame memory and means to detect changes between the contents of subsequent frames.

9. A display device as claimed in claim 1, wherein the means for recognizing the location comprise at least one of the group comprising a read-only structure and a programmable memory.

10. A display device as claimed in claim 1, wherein the drive means have a bus structure.
